(19) United States
(12) Patent Application Publication
(10) Pub. No.: US 2021/0301803 A1
(43) Pub. Date: Sep. 30, 2021

(54) VEHICLE ELECTRIC COMPRESSOR

(71) Applicant: KABUSHIKI KAISHA TOYOTA JIDOSHOKKI, Aichi-ken (JP)

(72) Inventors: Shunsuke AMBO, Aichi-ken (JP); Yoshiki NAGATA, Aichi-ken (JP); Takashi KAWASHIMA, Aichi-ken (JP); Hiroshi FUKASAKU, Aichi-ken (JP); Kaida JUNYA, Aichi-ken (JP); Takeshi HARASAWA, Aichi-ken (JP); Kenji HAYAKAWA, Aichi-ken (JP); Takuya SAGAWA, Aichi-ken (JP); Fumihiro KAGAWA, Aichi-ken (JP); Mikio YOSHIDA, Aichi-ken (JP); Kouki YAMAMOTO, Aichi-ken (JP)

(73) Assignee: KABUSHIKI KAISHA TOYOTA JIDOSHOKKI, Aichi-ken (JP)

(21) Appl. No.: 17/209,958

(22) Filed: Mar. 23, 2021

(30) Foreign Application Priority Data
Mar. 27, 2020 (JP) 2020-057695

(51) Int. Cl. F04B 35/04; H02K 11/33

(52) U.S. Cl. CPC F04B 35/04; H01F 27/292; H02K 11/33

(57) ABSTRACT

A vehicle electric compressor includes a compression part, an electric motor, and an inverter device. The inverter device includes a noise reduction unit that includes a common mode choke coil. The common mode choke coil includes a core, a first winding wire, a second winding wire, and an electrical conductor that covers the core. The electrical conductor has a first insulation layer and a second insulation layer. The first insulation layer, the electrical conductor, and the second insulation layer form a laminated body including a loop-shaped portion that covers the core and a joint portion.

### CROSS-REFERENCE TO RELATED APPLICATION

This application claims priority to Japanese Patent Application No. 2020-057695 filed on Mar. 27, 2020, the entire disclosure of which is incorporated herein by reference.

### BACKGROUND ART

The present disclosure relates to a vehicle electric compressor.

A common mode choke coil is used for an inverter device that drives an electric motor in a vehicle electric compressor. Japanese Patent Application Publication Nos. 2019-187228 and 2019-180218 disclose a technique that converts a current generated with a leakage magnetic flux to heat in a loop-shaped electrical conductor by employing, as a configuration of the common mode choke coil, a structure in which the loop-shaped electrical conductor covers a core while looped over a first winding wire and a second winding wire.

In the loop-shaped electrical conductor that covers the core while the loop-shaped electrical conductor is looped over the first winding wire and the second winding wire, a creepage distance needs to be ensured.

The present disclosure is directed to providing a vehicle electric compressor that ensures a creepage distance between a loop-shaped electrical conductor and first and second winding wires in a common mode choke coil of a noise reduction unit of an inverter device, wherein the loop-shaped electrical conductor covers a core while looped over the first winding wire and the second winding wire.

### SUMMARY

In accordance with an aspect of the present disclosure, there is provided a vehicle electric compressor that includes a compression part configured to compress fluid, an electric motor configured to drive the compression part, and an inverter device configured to drive the electric motor. The inverter device includes an inverter circuit configured to convert DC power to AC power, and a noise reduction unit that is connected to an input side of the inverter circuit and reduces a common mode noise and a normal mode noise in the DC power to be input to the inverter circuit. The noise reduction unit includes a common mode choke coil, and a smoothing capacitor that cooperates with the common mode choke coil to form a low pass filter circuit. The common mode choke coil includes a core that is formed in a ring shape, a first winding wire that is wound around the core, a second winding wire that is wound around the core, the second winding wire being separated from and facing the first winding wire, and an electrical conductor that is formed in a thin film shape and has flexibility, the electrical conductor covering the core in a loop shape while the electrical conductor is looped over the first winding wire and the second winding wire. The electrical conductor has a first insulation layer attached on one surface of the electrical conductor. The electrical conductor has a second insulation layer attached on the other surface of the electrical conductor. The electrical conductor includes a first end portion on which the second insulation layer is not disposed, and a second end portion on which the second insulation layer is not disposed and that is joined to the first end portion to form the loop shape of the electrical conductor. The first insulation layer, the electrical conductor, and the second insulation layer form a laminated body including a loop-shaped portion that covers the core and a joint portion that protrudes outward from the loop-shaped portion and in which the first end portion and the second end portion are joined. The laminated body has an end portion at which the electrical conductor is covered by at least one of the first insulation layer or the second insulation layer.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a schematic view illustrating a vehicle electric compressor according to an embodiment of the present disclosure;

FIG. 2 is a circuit diagram of a driving unit and an electric motor of FIG. 1;

FIG. 3A is a plan view of a circuit board and a common mode choke coil according to a first embodiment of the present disclosure;

FIG. 3B is a right side view of the circuit board and the common mode choke coil;

FIG. 4 is a cross-sectional view taken along a line IV-IV of FIG. 3A;

FIG. 5A is a plan view of the common mode choke coil;

FIG. 5B is a right side view of the common mode choke coil;

FIG. 6 is a cross-sectional view taken along a line VI-VI of FIG. 5A;

FIG. 7 is a perspective view of the common mode choke coil;

FIG. 8 is a bottom view of the common mode choke coil (as viewed in a direction of an arrow B of FIG. 6);

FIG. 9A is a plan view of a three-layer laminated body according to the first embodiment of the present disclosure;

FIG. 9B is a cross-sectional view taken along a line IXB-IXB of FIG. 9A;

FIG. 10A is a plan view of a copper foil according to the first embodiment of the present disclosure;

FIG. 10B is a front view of the copper foil:

FIG. 11A is a plan view of a cover film according to the first embodiment of the present disclosure;

FIG. 11B is a front view of the cover film;

FIG. 12A is a plan view of a base film according to the first embodiment of the present disclosure;

FIG. 12B is a front view of the base film;

FIG. 13A is a plan view of the common mode choke coil for an explanation of an operation according to the first embodiment of the present disclosure;

FIG. 13B is a cross-sectional view taken along a line XIIIB-XIIIB of FIG. 13A;

FIG. 14A is a plan view of a three-layer laminated body according to a second embodiment of the present disclosure;

FIG. 14B is a front view of the three-layer laminated body;

FIG. 15 is a cross-sectional view of a common mode choke coil according to the second embodiment of the present disclosure;

FIG. 16A is a plan view of a three-layer laminated body according to a third embodiment of the present disclosure;

FIG. 16B is a front view of the three-layer laminated body;

FIG. 17 is a cross-sectional view of a common mode choke coil according to the third embodiment of the present disclosure:

FIG. 18A is a plan view of a three-layer laminated body according to a fourth embodiment of the present disclosure;

FIG. 18B is a front view of the three-layer laminated body;

FIG. 19 is a cross-sectional view of a common mode choke coil according to the fourth embodiment of the present disclosure:

FIG. 20A is a plan view of a three-layer laminated body according to a fifth embodiment of the present disclosure;

FIG. 20B is a front view of the three-layer laminated body;

FIG. 21 is a cross-sectional view of a common mode choke coil according to a comparative example of the present disclosure;

FIG. 22A is a plan view of a three-layer laminated body according to the comparative example of the present disclosure;

FIG. 22B is a cross-sectional view taken along a line XXIIB-XXIIB of FIG. 22A; and

FIG. 22C is a bottom view of the three-layer laminated body according to the comparative example of the present disclosure.

### DETAILED DESCRIPTION OF THE EMBODIMENTS

### First Embodiment

The following will describe a first embodiment of the present disclosure with reference to the drawings. A vehicle electric compressor of the present embodiment includes a compression part configured to compress a refrigerant as fluid, and is used for a vehicle air conditioner. That is, the fluid that is compressed by the vehicle electric compressor in the present embodiment is a refrigerant.

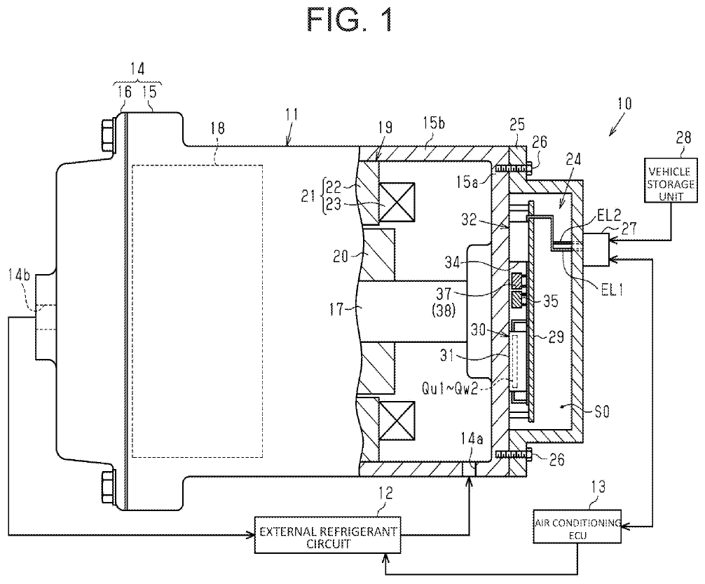

As illustrated in FIG. 1, a vehicle air conditioner 10 includes a vehicle electric compressor 11 and an external refrigerant circuit 12 that supplies a refrigerant as fluid to the vehicle electric compressor 11. The external refrigerant circuit 12 has a heat exchanger and an expansion valve, for example. The refrigerant is compressed by the vehicle electric compressor 11 and heat exchange and expansion of the refrigerant are performed by the external refrigerant circuit 12, by which the vehicle air conditioner 10 performs an air-conditioning in a vehicle.

The vehicle air conditioner 10 includes an air conditioning ECU 13 that controls the whole of the vehicle air conditioner 10. The air conditioning ECU 13 is configured in such a manner that the air conditioning ECU 13 monitors a temperature in the vehicle, a setting temperature of an air conditioner of the vehicle, etc., and sends a variety of commands such as a ON/OFF command to the vehicle electric compressor 11 in accordance with these parameters.

The vehicle electric compressor 11 includes a housing 14 that has an inlet 14a through which the refrigerant is taken from the external refrigerant circuit 12.

The housing 14 is made of a material that has thermal conductivity (for example, metal such as aluminum). The housing 14 is electrically grounded to a body of the vehicle. The housing 14 has a suction housing 15 and a discharge housing 16 that are assembled with each other. The suction housing 15 is formed in a bottomed cylindrical shape that opens in one direction, and has a bottom wall portion 15a that is formed in a plate shape and a peripheral wall portion 15b that extends toward the discharge housing 16 from a peripheral edge portion of the bottom wall portion 15a. One example of the bottom wall portion 15a is formed in a substantially plate shape, and one example of the peripheral wall portion 15b is formed in a substantially cylindrical shape. The discharge housing 16 is assembled with the suction housing 15 with an opening of the suction housing 15 closed by the discharge housing 16. Thus, a space is formed in the housing 14. The inlet 14a is formed in the peripheral wall portion 15b of the suction housing 15. In detail, the inlet 14a is disposed nearer the bottom wall portion 15a than the discharge housing 16 in the peripheral wall portion 15b of the suction housing 15. The housing 14 has an outlet 14b through which the refrigerant is discharged. The outlet 14b is formed in the discharge housing 16, or, more specifically, in a portion of the discharge housing 16 that faces the bottom wall portion 15a.

The vehicle electric compressor 11 includes a rotary shaft 17, a compression part 18, and an electric motor 19 that are accommodated in the housing 14.

The rotary shaft 17 is rotatably supported by the housing 14. The rotary shaft 17 is disposed with an axial direction of the rotary shaft 17 being the same as a thickness direction of the bottom wall portion 15a formed in the plate shape (in other words, an axial direction of the peripheral wall portion 15b formed in a cylindrical shape). The rotary shaft 17 and the compression part 18 are coupled with each other.

The compression part 18 is disposed nearer the outlet 14b than the inlet 14a (in other words, the bottom wall portion 15a) in the housing 14. The compression part 18 compresses the refrigerant taken into the housing 14 through the inlet 14a by rotation of the rotary shaft 17, and discharges the compressed refrigerant through the outlet 14b. It is noted that a specific configuration of the compression part 18 may be an arbitrary configuration such as a scroll type, a piston type, and a vane type.

The electric motor 19 is disposed between the compression part 18 and the bottom wall portion 15a in the housing 14. The electric motor 19 drives the compression part 18 by rotating the rotary shaft 17 in the housing 14. The electric motor 19 has, for example, a rotor 20 that is formed in a cylindrical shape and fixed to the rotary shaft 17, and a stator 21 that is fixed to the housing 14. The stator 21 has a stator core 22 that is formed in a cylindrical shape and a coil 23 that is wound around teeth formed in the stator core 22. The rotor 20 and the stator 21 face each other in a radial direction of the rotary shaft 17. The rotor 20 and the rotary shaft 17 are rotated by electrifying the coil 23, by which the refrigerant is compressed by the compression part 18.

As illustrated in FIG. 1, the vehicle electric compressor 11 includes a driving unit 24 to which DC power is input to drive the electric motor 19, and a cover member 25 which cooperates with the bottom wall portion 15a to form an accommodation chamber S0 in which the driving unit 24 is accommodated.

The cover member 25 is made of a non-magnetic conductive material that has thermal conductivity (for example, metal such as aluminum). The cover member 25 is formed in a bottomed cylindrical shape and opens toward the housing 14, or, more specifically, toward the bottom wall portion 15a of the suction housing 15. The cover member 25 is attached to the bottom wall portion 15a of the housing 14 by bolts 26 with an opening end of the cover member 25 in contact with the bottom wall portion 15a. An opening of the cover member 25 is sealed by the bottom wall portion 15a. The accommodation chamber S0 is formed of the cover member 25 and the bottom wall portion 15a. The accommodation chamber S0 is disposed outside the housing 14, and located on the opposite side of the bottom wall portion 15a relative to the electric motor 19. The compression part 18, the electric motor 19, and the driving unit 24 are arranged in the axial direction of the rotary shaft 17.

The cover member 25 has a connector 27, and the driving unit 24 is electrically connected to the connector 27. A DC current is input to the driving unit 24 from a vehicle storage device 28 mounted on the vehicle through the connector 27, and the air conditioning ECU 13 and the driving unit 24 are electrically connected. The vehicle storage device 28 is a DC power source such as a secondary battery and a capacitor that is mounted on the vehicle.

As illustrated in FIG. 1, a circuit board 29 is disposed in the accommodation chamber S0. The circuit board 29 is formed in a plate shape. The circuit board 29 and the bottom wall portion 15a are spaced a specified distance apart in the axial direction of the rotary shaft 17 and face each other. The driving unit 24 has an inverter device 30, and a first connection line EL1 and a second connection line EL2 that are used to electrically connect the inverter device 30 to the connector 27. The driving unit 24 is configured by using the circuit board 29.

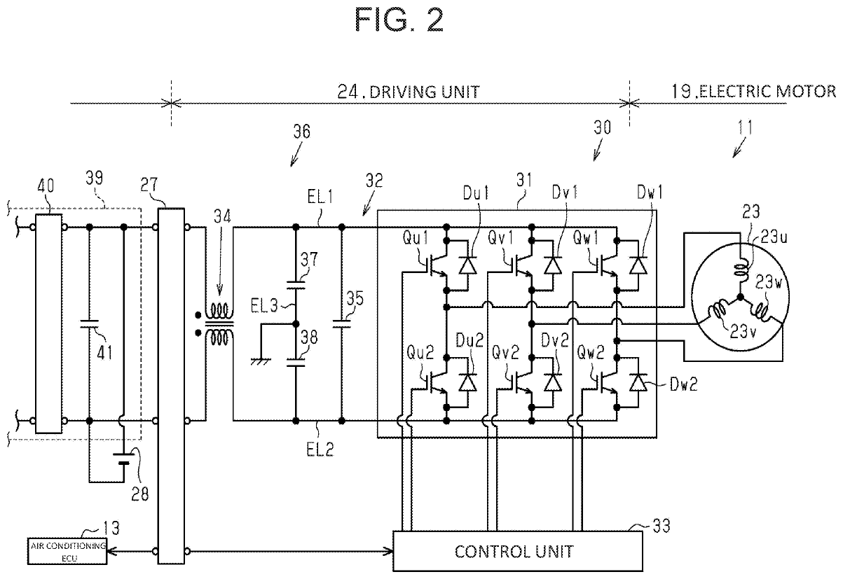

The inverter device 30 is used to drive the electric motor 19. The inverter device 30 includes an inverter circuit 31 (see FIG. 2) and a noise reduction unit 32 (see FIG. 2). The inverter circuit 31 is used to convert DC power to AC power. The noise reduction unit 32 is connected to an input side of the inverter circuit 31 and reduces a common mode noise and a normal mode noise in the DC power to be input to the inverter circuit 31.

The following will describe an electrical configuration of the electric motor 19 and the driving unit 24.

As illustrated in FIG. 2, the coil 23 of the electric motor 19 has a three phase structure that has, for example, a u-phase coil 23u, a v-phase coil 23v, and a w-phase coil 23w. The coils 23u to 23w are, for example, Y-connected. The inverter circuit 31 includes u-phase switching elements Qu1, Qu2 corresponding to the u-phase coil 23u, v-phase switching elements Qv1, Qv2 corresponding to the v-phase coil 23v, and w-phase switching elements Qw1, Qw2 corresponding to the w-phase coil 23w. A power switching element such as IGBT is used as each of the switching elements Qu1 to Qw2. It is noted that the switching elements Qu1 to Qw2 have freewheeling diodes (body diodes) Du1 to Dw2, respectively. The u-phase switching elements Qu1, Qu2 are connected in series through a connection line which is connected to the u-phase coil 23u. A series-connected body of the u-phase switching elements Qu1, Qu2 is electrically connected to both of the connection lines EL1, EL2. The DC current flowing from the vehicle storage device 28 is input to the above-described series-connected body. It is noted that the other switching elements Qv1, Qv2, Qw1, Qw2 are connected in the same manner as the u-phase switching elements Qu1, Qu2, except only that the corresponding coils each connected to the switching elements Qv1, Qv2, Qw1, Qw2 are different from that of the switching elements Qu1, Qu2.

The driving unit 24 includes a control unit 33 that controls a switching operation of each of the switching elements Qu1 to Qw2. The control unit 33 is formed of, for example, one or more dedicated hardware circuits, and/or one or more processors (control circuits) that are operated in accordance with computer programs (software). The processor includes a CPU and a memory such as a RAM and a ROM. The memory stores program codes or commands by which, for example, the processor executes a variety of processes. The memory, that is, a computer-readable medium herein refers to every applicable medium to which a general-purpose or dedicated computer is accessible.

The control unit 33 is electrically connected to the air conditioning ECU 13 through the connector 27, and periodically turns on and off each of the switching elements Qu1 to Qw2 in accordance with commands from the air conditioning ECU 13. In detail, the control unit 33 controls each of the switching elements Qu1 to Qw2 by a pulse width modulation control (PWM control) in accordance with the commands from the air conditioning ECU 13. More specifically, the control unit 33 generates control signals by using a carrier signal (carrier wave signal) and command voltage signals (reference signals). The control unit 33 performs an ON/OFF control of each of the switching elements Qu1 to Qw2 by using the generated control signals to convert the DC power to the AC power.

The noise reduction unit 32 includes the circuit board 29 (see FIG. 1), a common mode choke coil 34 that is mounted on the circuit board 29, and an X capacitor 35 that is mounted on the circuit board 29. The X capacitor 35 as a smoothing capacitor cooperates with the common mode choke coil 34 to form a low pass filter circuit 36. The low pass filter circuit 36 is connected to the connection lines EL1 and EL2. The low pass filter circuit 36 is connected between the connector 27 and the inverter circuit 31 in the electrical circuit. The common mode choke coil 34 is connected to the connection lines EL1 and EL2. The X capacitor 35 is connected in an output stage of the common mode choke coil 34 (electrically closer to the inverter circuit 31) and electrically connected to the connection lines EL1 and EL2. The common mode choke coil 34 cooperates with the X capacitor 35 to form a LC resonance circuit. That is, the low pass filter circuit 36 of the present embodiment is the LC resonance circuit that includes the common mode choke coil 34.

Y capacitors 37, 38 are connected in series with each other. In detail, the driving unit 24 includes a bypass line EL3 that connects a first end of a first Y capacitor 37 to a first end of a second Y capacitor 38. The bypass line EL3 is electrically grounded to the body of the vehicle. In addition, a series-connected body of both of the Y capacitors 37, 38 is connected between the X capacitor 35 and the common mode choke coil 34, and electrically connected to the common mode choke coil 34. A second end of the first Y capacitor 37 opposite the first end thereof is connected to the first connection line EL1, or, more specifically, a node at which a first winding wire of the common mode choke coil 34 and the inverter circuit 31 are connected in the first connection line EL1. A second end of the second Y capacitor 38 opposite the first end thereof is connected to the second connection line EL2, or, more specifically, a node at which a second winding wire of the common mode choke coil 34 and the inverter circuit 31 are connected in the second connection line EL2.

A PCU (power control unit) 39 as an example of a vehicle equipment is provided separately from the driving unit 24 on the vehicle. The PCU 39 drives a traveling motor or the like that is mounted on the vehicle by using DC power supplied from the vehicle storage device 28. That is, in the present embodiment, the PCU 39 and the driving unit 24 are connected in parallel with the vehicle storage device 28, that is, the vehicle storage device 28 is shared between the PCU 39 and the driving unit 24. The PCU 39 includes, for example, a boost converter 40 that has a boost switching element and raises the DC power of the vehicle storage device 28 by turning on and off the boost switching element periodically, and a power supply capacitor 41 that is connected in parallel with the vehicle storage device 28. In addition, the PCU 39 includes a travelling inverter (not illustrated) that converts the DC power raised by the boost converter 40 to drive power by which the traveling motor is driven.

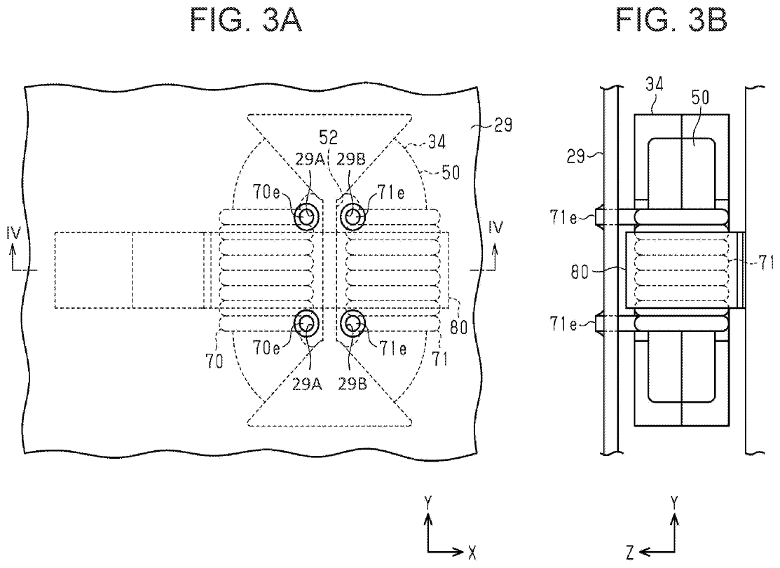

The following will describe a configuration of the common mode choke coil 34 with reference to FIGS. 3A, 3B, 4, 5A, 5B, 6, 7, 9A, 9B, 10A, 10B, 11A, 11B, 12A, 12B, 13A, and 13B.

It is noted that a three-axis orthogonal coordinate is specified in the drawings. In the present embodiment, an axial direction of the rotary shaft 17 in FIG. 1 is defined as a Z-direction, and directions orthogonal to the Z-direction are defined as an X-direction and a Y-direction.

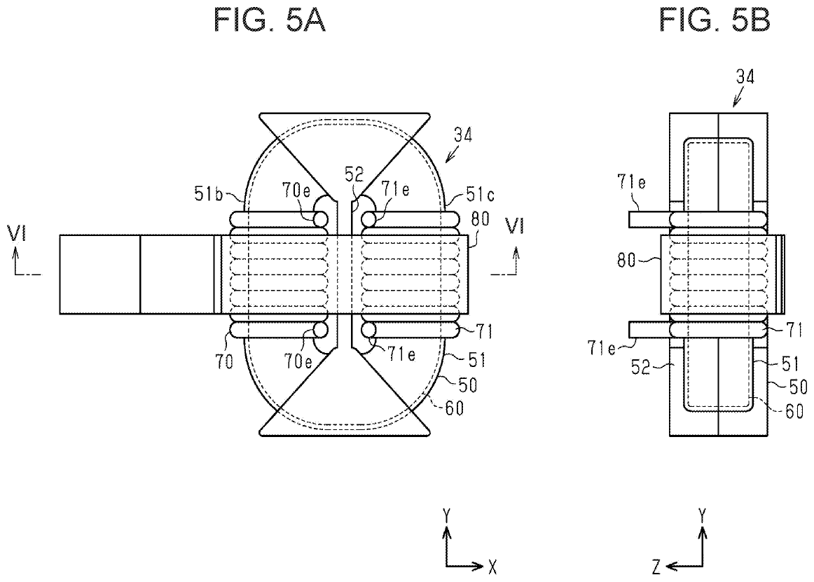

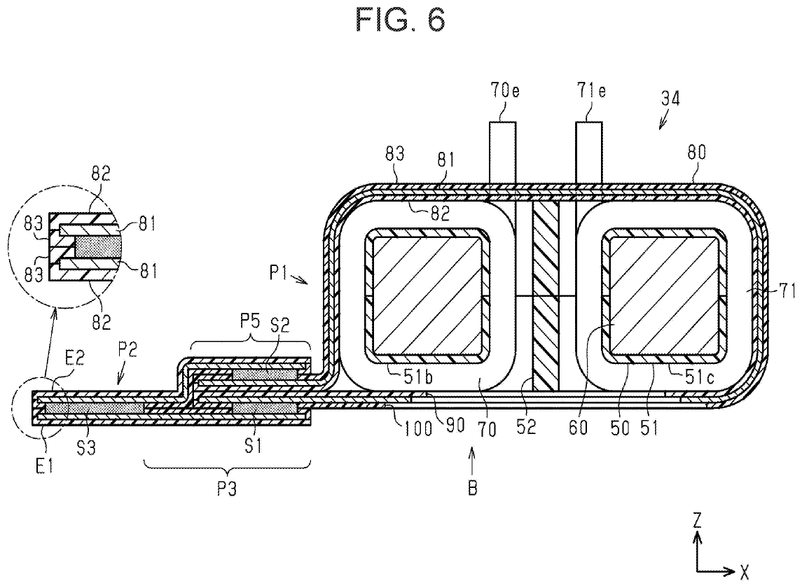

As illustrated in FIGS. 5A, 5B, and 6, the common mode choke coil 34 includes a case 50, a core 60, a first winding wire 70, a second winding wire 71, and a three-layer laminated body 80 that is formed in a strip sheet shape and has a copper foil 81 as a loop-shaped electrical conductor. The winding wires 70, 71 are wound around the case 50 in which the core 60 is accommodated. The common mode choke coil 34 is used with the three-layer laminated body 80 wound around the winding wires 70, 71 in a loop shape.

As illustrated in FIGS. 5A, 5B, and 6, the core 60 is accommodated in the case 50. The core 60 has a cross-sectional shape of a quadrangle as illustrated in FIG. 6, and has a ring shape of a substantially rectangle as a whole in an X-Y plane illustrated in FIG. 5A.

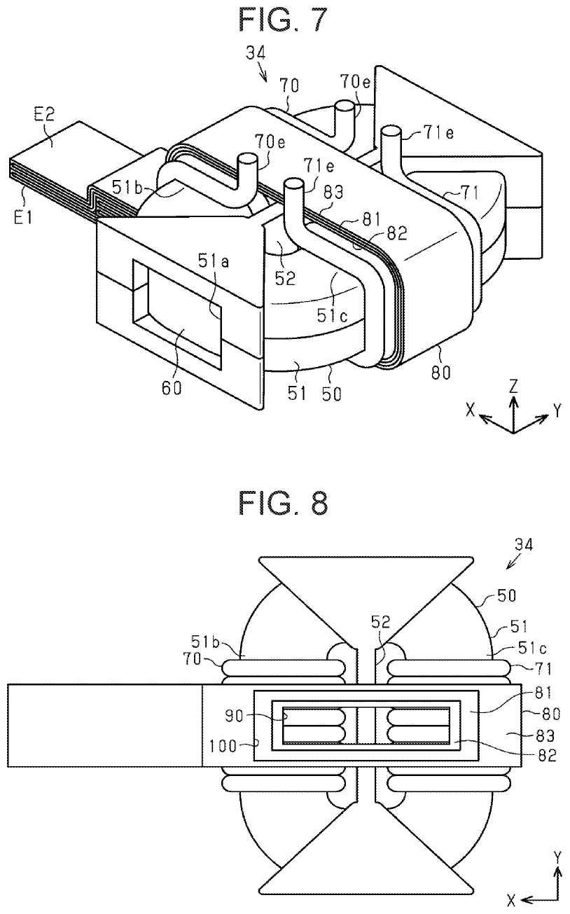

As illustrated in FIGS. 5A, 5B and 6, the case 50 has a ring shape and electrical insulating property, and is made of resin. The case 50 includes a main body portion 51 that has an opening 51a, and a wall 52. The main body portion 51 excluding the opening 51a (see FIG. 7) covers an entire portion of the core 60. The winding wires 70, 71 are wound around the main body portion 51 as illustrated in FIGS. 5A, 5B, and 6. The opening 51a of FIG. 7 is disposed between the winding wires 70, 71. A portion of the core 60 that is located between the winding wires 70, 71 is exposed outside the case 50 through the opening 51a.

The wall 52 is located on an inner peripheral surface side of the core 60 between the winding wires 70, 71, and formed to extend in the Z-direction. The winding wires 70, 71 are separated by the wall 52.

As illustrated in FIGS. 5A, 5B, and 6, the first winding wire 70 is wound around an outer surface of the case 50. The second winding wire 71 is wound around the outer surface of the case 50. In detail, the main body portion 51 of the case 50 includes a first straight line portion 51b and a second straight line portion 51c which extend straight in parallel with each other. At least one part of the first winding wire 70 is wound around the first straight line portion 51b. At least one part of the second winding wire 71 is wound around the second straight line portion 51c. Winding directions of both of the winding wires 70, 71 are mutually opposite directions. In addition, the first winding wire 70 and the second winding wire 71 are separated away and face each other.

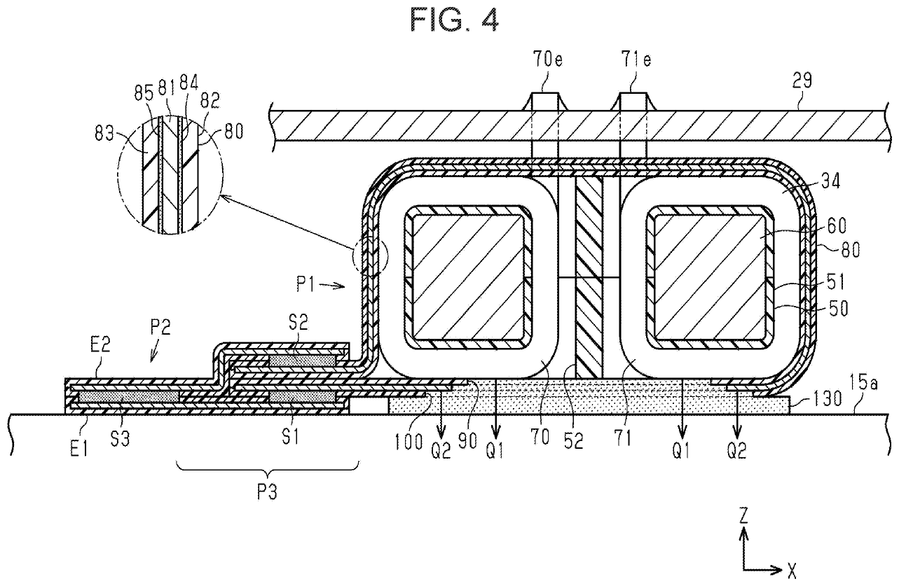

As illustrated in FIG. 4, the three-layer laminated body 80 is formed by laminating a base film 82 and a cover film 83 with the copper foil 81 sandwiched therebetween. In detail, the base film 82 adheres to one side of the copper foil 81 by an adhesive agent 84, and the cover film 83 adheres to the other side of the copper foil 81 by an adhesive agent 85. The base film 82 as a first insulation layer and the cover film 83 as a second insulation layer are made of polyimide. It is noted that the base film 82 and the copper foil 81 may adhere to each other by heat-welding, etc., without the adhesive agent 84 between the base film 82 and the copper foil 81. The three-layer laminated body 80 that is formed in the strip shape extends in the X-direction.

The copper foil 81 is formed in a thin film shape and has flexibility. The copper foil 81 covers the core 60 in a loop shape while looped over the first winding wire 70 and the second winding wire 71.

The base film 82 has flexibility and adheres to one side of the copper foil 81. The cover film 83 has flexibility and adheres to the other side of the copper foil 81.

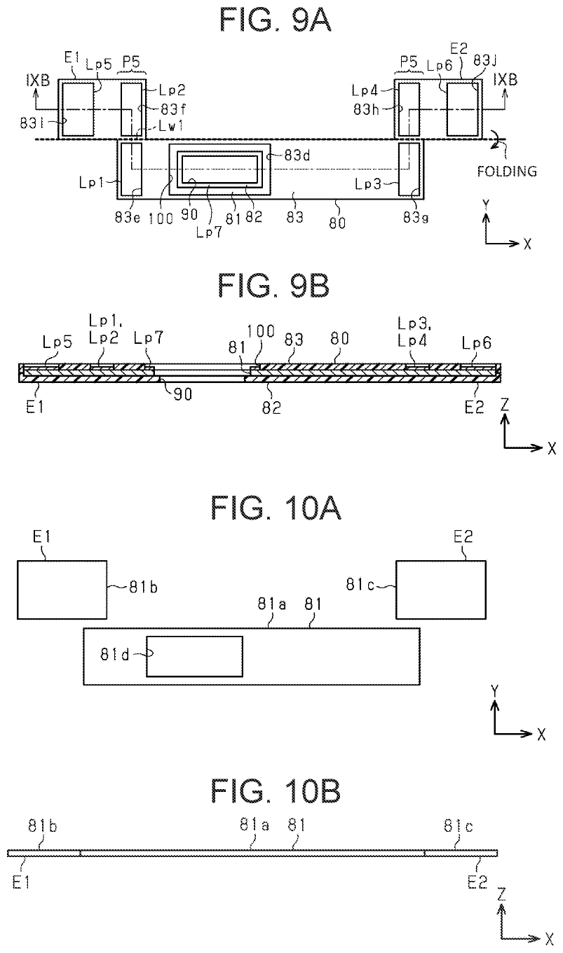

The copper foil 81 includes a first end portion E1 on which the cover film 83 is not disposed as illustrated by an opening 83i of FIG. 9A. The copper foil 81 also includes a second end portion E2 on which the cover film 83 is not disposed as illustrated by an opening 83j of FIG. 9A and that is joined to the first end portion E1 by solder S3 (see FIG. 6) to form the loop shape (see FIG. 6) of the copper foil 81.

As illustrated in FIG. 6, the loop-shaped three-layer laminated body 80 is formed of the base film 82, the copper foil 81, and the cover film 83. The copper foil 81 is covered by the base film 82 and the cover film 83 at an end portion (that is formed by joining the first end portion E1 on the left side and the second end portion E2 on the right side in FIG. 9B) of the loop-shaped three-layer laminated body 80. Thus, the three-layer laminated body 80 has the same structure as a general flexible printed circuit board. That is, the three-layer laminated body 80 may be considered as the flexible printed circuit board.

As illustrated in FIG. 6, the loop-shaped three-layer laminated body 80 has a loop-shaped portion P1, a joint portion P2, and an overlap portion P3. The loop-shaped portion P1 covers the core 60. The joint portion P2 protrudes outward from the loop-shaped portion P1. The first end portion E1 and the second end portion E2 are joined in the joint portion P2. Specifically, the end portions E1 and E2 of the copper foil 81 are joined by the solder S3. The overlap portion P3 in which the cover film 83 overlaps itself is located between the loop-shaped portion P1 and the joint portion P2, and extends toward the joint portion P2 from the loop-shaped portion P1.

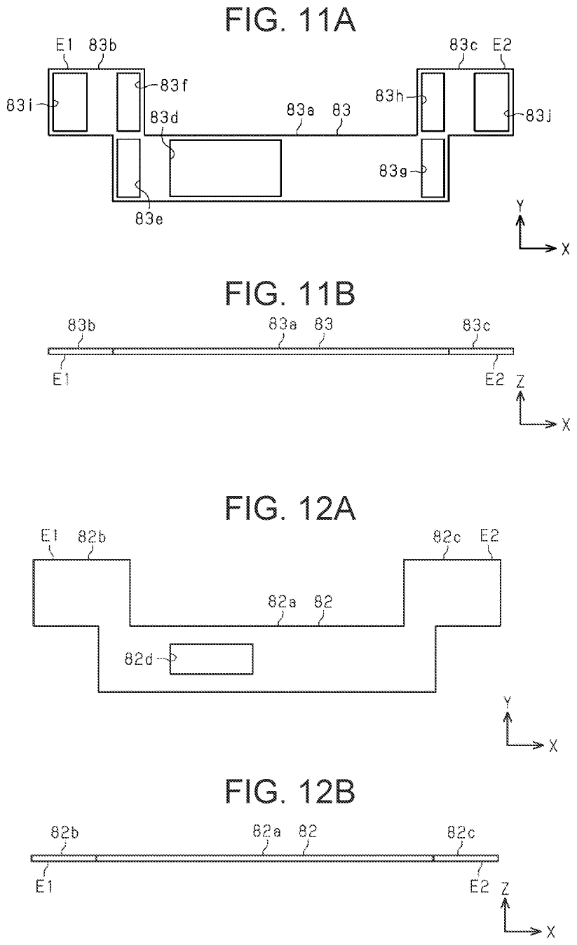

As illustrated in FIGS. 6 and 8, the three-layer laminated body 80 has a through hole 90 for exposing the first winding wire 70 and the second winding wire 71 so as to dissipate heat. That is, the copper foil 81 has a through hole 81d of a rectangular shape as illustrated in FIG. 10A, the cover film 83 has an opening 83d of a rectangular shape as illustrated in FIG. 11A, and the base film 82 has a through hole 82d of a rectangular shape as illustrated in FIG. 12A. The through hole 81d of the copper foil 81, the opening 83d of the cover film 83, and the through hole 82d of the base film 82 are overlapped with each other, by which the through hole 90 of a rectangular shape of the three-layer laminated body 80 in FIGS. 6 and 8 is formed.

As illustrated in FIGS. 6 and 8, the three-layer laminated body 80 has an opening 100 for uncovering the copper foil 81 that surrounds an edge portion of the copper foil 81 around the through hole 90 so as to dissipate heat. That is, the opening 83d of the rectangular shape of the cover film 83 illustrated in FIG. 11A is formed larger than the through hole 81d of the copper foil 81 illustrated in FIG. 10A, so that the opening 100 of the rectangular shape for uncovering the copper foil 81 that surrounds the edge portion of the copper foil 81 around the through hole 90 is formed in the three-layer laminated body 80 of FIGS. 6 and 8. In addition, the through hole 82d of the base film 82 illustrated in FIG. 12A is smaller than the through hole 81d of the copper foil 81 illustrated in FIG. 10A, so that the base film 82 protrudes radially inward from the through hole 81d of the copper foil 81 in the three-layer laminated body 80 illustrated in FIG. 8. Thus, insulation between the uncovered copper foil 81 and the winding wires 70, 71 is further ensured.

The three-layer laminated body 80 illustrated in FIG. 9A has the through hole 90 for heat dissipation, the opening (uncovered portion of the copper foil) 100 for heat dissipation that is larger than the through hole 90, a pair of openings (uncovered portions of the copper foil) for soldering 83e and 83f, a pair of openings (uncovered portions of the copper foil) for soldering 83g and 83h, and a pair of the openings (uncovered portions of the copper foil) for soldering 83i and 83j in the opposite end portions E1 and E2.

As illustrated in FIG. 9A, the three-layer laminated body 80 is configured to be folded along a folding line Lw1 that extends in the X-direction.

In the three-layer laminated body 80 that is to be folded, the copper foil 81 has a configuration illustrated in FIGS. 10A and 10B, the base film 82 has a configuration illustrated in FIGS. 12A and 12B, and the cover film 83 has a configuration illustrated in FIGS. 11A and 11B.

In FIGS. 10A and 10B, the copper foil 81 has a copper foil 81a, a copper foil 81b, a copper foil 81c. The copper foil 81a is formed in a strip shape and extends in the X-direction. The copper foil 81b is separated from one end portion of the copper foil 81a in the Y-direction, and the copper foil 81c is separated from the other end portion of the copper foil 81a in the Y-direction. The copper foil 81a has the through hole 81d of a rectangular shape. The folding line Lw1 of FIG. 9A extends between the copper foil 81a and the copper foils 81b, 81c in FIG. 10A.

In FIGS. 12A and 12B, the base film 82 has a first rectangular portion 82a, a second rectangular portion 82b, and a third rectangular portion 82c. The first rectangular portion 82a extends in the X-direction. The second rectangular portion 82b is continued with a left end of the first rectangular portion 82a in a longitudinal direction thereof and located on one side of the first rectangular portion 82a in a short direction thereof, and the third rectangular portion 82c is continued with a right end of the first rectangular portion 82a in the longitudinal direction thereof and located on the same side of the first rectangular portion 82a as the second rectangular portion 82b. The first rectangular portion 82a has the through hole 82d of the rectangular shape. The folding line Lw1 of FIG. 9A extends through a boundary between the first rectangular portion 82a and the second rectangular portion 82b and a boundary between the first rectangular portion 82a and the third rectangular portion 82c in FIG. 12A.

In FIGS. 11A and 11B, the cover film 83 has a first rectangular portion 83a, a second rectangular portion 83b, and a third rectangular portion 83c. The first rectangular portion 83a extends in the X-direction. The second rectangular portion 83b is continued with a left end of the first rectangular portion 83a in a longitudinal direction thereof and located on one side of the first rectangular portion 83a in a short direction thereof, and the third rectangular portion 83c is continued with a right end of the first rectangular portion 83a in the longitudinal direction thereof and located on the same side of the first rectangular portion 83a as the second rectangular portion 83b. The opening 83d of the rectangular shape is formed proximate to the middle of the first rectangular portion 83a. The opening 83e of the rectangular shape is formed in a left end portion of the first rectangular portion 83a. The opening 83f of the rectangular shape is formed in a right end portion of the second rectangular portion 83b. The opening 83g of the rectangular shape is formed in a right end portion of the first rectangular portion 83a. The opening 83h of the rectangular shape is formed in a left end portion of the third rectangular portion 83c. The opening 83i of the rectangular shape is formed in a left end portion of the second rectangular portion 83b. The opening 83j of the rectangular shape is formed in a right end portion of the third rectangular portion 83c. The folding line Lw1 of FIG. 9A extends through a boundary between the first rectangular portion 83a and the second rectangular portion 83b and a boundary between the first rectangular portion 83a and the third rectangular portion 83c in FIG. 11A.

The copper foil 81a that is uncovered by the opening 83e illustrated in FIG. 11A and the copper foil 81b that is uncovered by the opening 83f are joined to each other with gold plated layers Lp1, Lp2 (see FIG. 9) interposed therebetween by solder S1 (see FIG. 6). In addition, the copper foil 81a that is uncovered by the opening 83g illustrated in FIG. 11A and the copper foil 81c that is uncovered by the opening 83h are joined to each other with gold plated layers Lp3, Lp4 (see FIG. 9) interposed therebetween by solder S2 (see FIG. 6).

The copper foil 81b that is uncovered by the opening 83i illustrated in FIG. 11A and the copper foil 81c that is uncovered by the opening 83j are joined to each other with gold plated layers Lp5, Lp6 (see FIG. 9) interposed therebetween by the solder S3 (see FIG. 6).

The soldering is facilitated by forming the gold plated layers Lp1 to Lp6 on a surface in each soldering area of the copper foil 81.

As illustrated in FIGS. 6 and 9A, the three-layer laminated body 80 has a folded portion P5 in which the base film 82 is folded back so that the base film 82 overlaps itself, and the folded portion P5 has uncovered surfaces on which the cover film 83 is not formed due to the openings 83e, 83f, 83g, and 83h.

In addition, as illustrated in FIGS. 9A and 9B, a gold plated layer Lp7 is formed in the opening 100 (uncovered portion of the copper foil) of the three-layer laminated body 80 as a heat dissipation portion of the copper foil 81. The gold plated layer Lp7 prevents corrosion of the opening 100 (uncovered portion of the copper foil) of the three-layer laminated body 80.

As illustrated in FIG. 6, the loop-shaped copper foil 81 covers the core 60 and the case 50 while looped over the first winding wire 70 and the second winding wire 71. Portions of the copper foil 81 that are located between the first winding wire 70 and the second winding wire 71 are separated and face each other.

As illustrated in FIGS. 3A, 3B, and 4, opposite ends 70e of the first winding wire 70 that is wound around one part of the core 60 protrude from the circuit board 29 through through holes 29A of the circuit board 29, and are soldered to the circuit board 29. The second winding wire 71 that is wound around the other part of the core 60 is separated from and faces the first winding wire 70. Opposite ends 71e of the second winding wire 71 protrude from the circuit board 29 through through holes 29B of the circuit board 29, and are soldered to the circuit board 29. The ends 70e of the first winding wire 70 and the ends 71e of the second winding wire 71 are, by soldering, electrically connected to conductive patterns formed on the circuit board 29.

As illustrated in FIG. 5A, short side portions of the case 50 formed in a rectangle shape (ring shape) are uncovered portions that are not covered by the copper foil 81 of the three-layer laminated body 80.

As illustrated in FIG. 4, a heat dissipation member (such as heat dissipation grease and a heat dissipation sheet) 130 is disposed on a facing surface of the three-layer laminated body 80 that faces the bottom wall portion 15a of the suction housing 15. Thus, the winding wires 70, 71 and the copper foil 81 are thermally coupled to the suction housing 15 and indeed to the housing 14.

The following will describe a manufacture of the common mode choke coil 34 of the present embodiment.

As illustrated in FIGS. 9A and 9B, the three-layer laminated body 80 is prepared. As illustrated in FIG. 9A, the three-layer laminated body 80 is folded along the folding line Lw1 illustrated by a dashed line. As illustrated in FIG. 6, the copper foil 81 uncovered by the opening 83e (see FIG. 11A) of the cover film 83 and the copper foil 81 uncovered by the opening 83f (see FIG. 11A) of the cover film 83 are joined by the solder S1. The copper foil 81 uncovered by the opening 83g (see FIG. 11A) of the cover film 83 and the copper foil 81 uncovered by the opening 83h (see FIG. 11A) of the cover film 83 are also joined by the solder S2. The copper foil 81 uncovered by the opening 83i (see FIG. 11A) of the cover film 83 and the copper foil 81 uncovered by the opening 83j (see FIG. 11A) of the cover film 83 are also joined by the solder S3. Before the soldering, the gold plated layers Lp7, Lp1, Lp2, Lp3, Lp4, Lp5, and Lp6 are formed on the surfaces of the copper foil 81 uncovered by the openings 83d, 83e, 83f, 83g, 83h, 83i and 83j, respectively.

As illustrated in FIGS. 5A, 5B, and 6, the core 60 is housed in the case 50, and then, the first winding wire 70 and the second winding wire 71 are wound around the case 50. The first end portion E1 and the second end portion E2 of the copper foil 81 are soldered to each other when the three-layer laminated body 80 formed of the base film 82, the copper foil 81, and the cover film 83 is wound around the case 50 that has the core 60 and the winding wires 70, 71. In this time, the first end portion E1 and the second end portion E2 of the copper foil 81 may be soldered to each other with the three-layer laminated body 80 wound around an outer periphery of the winding wires 70, 71, or the three-layer laminated body 80 may be disposed on the outer periphery side of the winding wires 70, 71 after the first end portion E1 and the second end portion E2 of the copper foil 81 are soldered to each other.

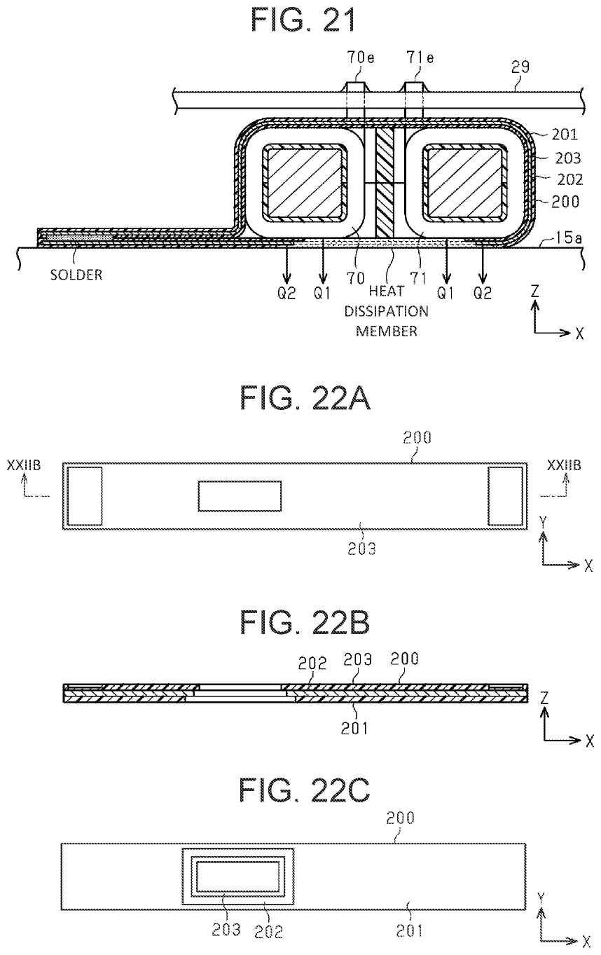

FIGS. 21, 22A, 22B, and 22C illustrate a comparative example of the present embodiment.

A three-layer laminated body 200 has a structure illustrated in FIG. 21 in which a copper foil 202 is uncovered on each side of a cover film 203 and a base film 201 by freely forming openings in the base film 201 and the cover film 203 that are attached to both sides of the copper foil 202, as illustrated in FIGS. 22A, 22B, and 22C. Such a structure of the three-layer laminated body 200 is not made because of a manufacturing constraint. That is, after the copper foil 202 is caused to adhere to the base film 201 and the cover film 203 is caused to adhere to the copper foil 202, openings of a desired shape are formed on only the cover film 203 by etching. Thus, while the openings of the desired shape are formed on the cover film 203, an opening of the desired shape is not formed on the base film 201, so that the structure of the three-layer laminated body 80 has one-side openings by which the copper foil 202 is uncovered, and does not have opposite-side openings.

The following will describe an advantageous effect according to the present embodiment.

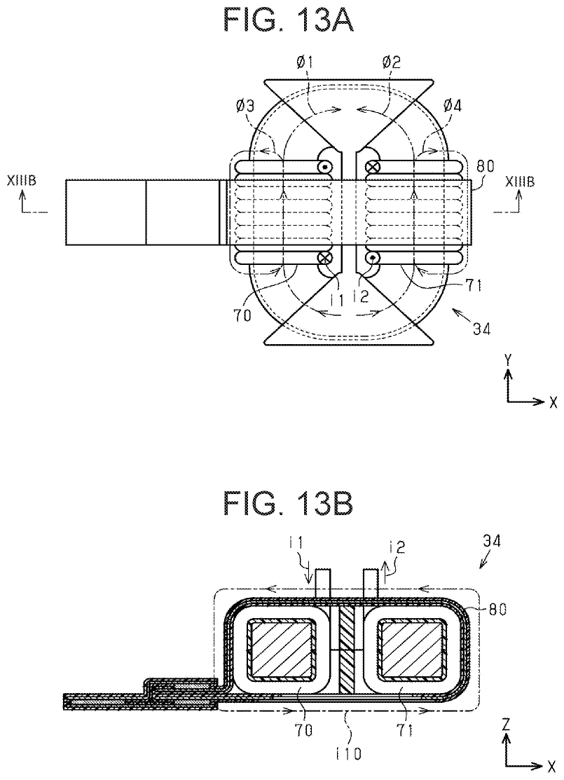

Firstly, a normal mode (differential mode) will be described by using FIGS. 13A and 13B.

As illustrated in FIG. 13A, when the first winding wire 70 and the second winding wire 71 are energized, currents i1, i2 flow through the first winding wire 70 and the second winding wire 71, respectively. In response to the currents i1, i2 flowing through the winding wires 70, 71, magnetic fluxes φ1, φ2 are generated in the core 60, and leakage magnetic fluxes φ3, φ4 are generated around the core 60. Here, as illustrated in FIG. 13B, an induced current i10 flows in the loop-shaped copper foil 81 in a circumferential direction thereof so as to generate a magnetic flux which flows in a direction against the generating leakage magnetic fluxes φ3, φ4.

Thus, in the copper foil 81, the induced current (eddy current) i10 flows in the circumferential direction of the copper foil 81 so as to generate the magnetic flux in the direction against the leakage magnetic fluxes that are generated in accordance with the energizing of the first winding wire 70 and the second winding wire 71. The induced current flowing in the circumferential direction herein refers to the induced current flowing around the core 60.

In a common mode, the currents flow in the same direction as each other through the first winding wire 70 and the second winding wire 71 by the energizing of the first winding wire 70 and the second winding wire 71. Magnetic fluxes in the same direction as each other are generated in the core 60 in response to the currents flowing through the first winding wire 70 and the second winding wire 71. Thus, when a common mode current flows, the magnetic fluxes are generated in the core 60 while few leakage magnetic fluxes are generated, so that a common impedance is maintained.

The current flows in the copper foil 81 that is formed in the strip shape and an endless-loop shape so as to generate the magnetic flux in the direction against the leakage magnetic fluxes, and power is consumed to generate heat.

In addition, the copper foil 81 at the joined end portions E1, E2 of the loop-shaped three-layer laminated body 80 is covered by the base film 82 and the cover film 83, so that a creepage distance between the loop-shaped copper foil 81 and the winding wires 70, 71 may be ensured.

Thus, the induced current flows in the copper foil 81 being the loop-shaped electrical conductor that is wound around the common mode choke coil 34, and power is consumed in the copper foil 81, so that a resonance peak may be suppressed. In particular, the common mode choke coil 34 is superior in an insulation property and mountability by using the three-layer laminated body 80 that has flexibility. That is, the copper foil 81 may be insulated by sandwiching the copper foil 81 between the base film 82 and the cover film 83 made of polyimide, by which the insulation property may be ensured. The common mode choke coil 34 is superior in pliability and the flexibility in addition to the insulation property, so that the common mode choke coil 34 is also superior in the mountability.

As illustrated in FIG. 4, heat Q1 generated in the winding wires 70 and 71 escapes into the bottom wall portion 15a through the heat dissipation member 130 because the winding wires 70, 71 are thermally connected to the bottom wall portion 15a. Thus, the common mode choke coil 34 is superior in heat dissipation performance to a heat dissipation surface.

As illustrated in FIG. 4, heat Q2 generated in the copper foil 81 escapes into the bottom wall portion 15a through the heat dissipation member 130 since the copper foil 81 is thermally connected to the bottom wall portion 15a. Thus, the common mode choke coil 34 is superior in the heat dissipation performance to the heat dissipation surface. That is, the heat dissipation performance of the common mode choke coil 34 is improved by forming an opening in the copper foil 81 of the three-layer laminated body 80, and directly dissipating heat generated in the copper foil 81 into the bottom wall portion 15a made of aluminum through the heat dissipation member 130.

As described by using FIGS. 21, 22A, 22B, and 22C, only one-side openings to the copper foil 81 on the cover film side may be formed in the three-layer laminated body 80 due to the manufacturing constraint, and the opposite-side openings of the copper foil 81 is not formed. In the present embodiment, the three-layer laminated body 80 has the one-side openings, and achieves an equivalent function to the three-layer laminated body that has the opposite-side openings by devising the shape of the three-layer laminated body.

According to the above-described embodiment, the following advantageous effects are obtained.

(1) The vehicle electric compressor 11 includes the compression part 18 that compresses a refrigerant as the fluid, the electric motor 19 that drives the compression part 18, and the inverter device 30 that drives the electric motor 19. The inverter device 30 includes the inverter circuit 31 that converts DC power to AC power and the noise reduction unit 32 that is connected to the input side of the inverter circuit 31 and reduces a common mode noise and a normal mode noise in the DC power that is to be input to the inverter circuit 31. The noise reduction unit 32 includes the common mode choke coil 34 and the X capacitor 35 as the smoothing capacitor that cooperates with the common mode choke coil 34 to form the low pass filter circuit 36. The common mode choke coil 34 includes: the core 60 that is formed in a ring shape; the first winding wire 70 that is wound around the core 60; the second winding wire 71 that is wound around the core 60, and is separated from and faces the first winding wire 70; and the copper foil 81 as the electrical conductor that is formed in a thin film shape and has flexibility, wherein the copper foil 81 covers the core 60 in a loop shape while looped over the first winding wire 70 and the second winding wire 71. The copper foil 81 has the base film 82 as the first insulation layer that has flexibility attached on one surface of the copper foil 81, and has the cover film 83 as the second insulation layer that has flexibility attached on the other surface of the copper foil 81. The copper foil 81 includes the first end portion E1 on which the cover film 83 is not disposed and the second end portion E2 on which the cover film 83 is not disposed and that is joined to the first end portion E1 to form the loop shape of the copper foil 81. The three-layer laminated body 80 as a laminated body formed of the base film 82, the copper foil 81, and the cover film 83 includes the loop-shaped portion P1 that covers the core 60 and the joint portion P2 that protrudes outward from the loop-shaped portion P1 and in which the first end portion E1 and the second end portion E2 are joined. The copper foil 81 is covered by the base film 82 and the cover film 83 at the end portions E1, E2 of the three-layer laminated body 80.

Thus, in the common mode choke coil 34 of the noise reduction unit 32 of the inverter device 30, the creepage distance between the winding wires 70, 71 and the copper foil 81 that covers the core 60 in the loop shape while the copper foil 81 is looped over the first winding wire 70 and the second winding wire 71 may be ensured.

The copper foil 81 is covered by the base film 82 and the cover film 83, so that a solder ball is difficult to be attached when the opposite end portions of the copper foil 81 of the three-layer laminated body 80 formed of the base film 82, the copper foil 81, and the cover film 83 are soldered to each other.

After the copper foil 81 is wound around the winding wires 70, 71, the copper foil 81 is made in the loop shape by soldering the opposite end portions of the copper foil 81. In this time, heat by the soldering is difficult to affect the winding wires 70, 71 due to a soldering portion that is separated from the winding wires 70, 71.

(2) The three-layer laminated body 80 has the overlap portion P3 in which the cover film 83 overlaps itself, and that is located between the loop-shaped portion P1 and the joint portion P2 and extends toward the joint portion P2 from the loop-shaped portion P1. This configuration is preferable in view of ensuring a creepage distance between the joint portion P2 of the first end portion E1 and the second end portion E2, and the winding wires 70, 71.

(3) The three-layer laminated body 80 has the through hole 90 for exposing the first winding wire 70 and the second winding wire 71 so as to dissipate heat. Thus, the present embodiment is superior in heat dissipation performance of the winding wires 70, 71.

(4) Of the base film 82 and the cover film 83, the cover film 83 as the insulation layer that is located on an outer peripheral side of the loop-shaped three-layer laminated body 80 has the opening 100 by which the copper foil 81 is uncovered from the cover film 83 to dissipate heat. Thus, the present embodiment is superior in heat dissipation performance of the copper foil 81.

(5) The three-layer laminated body 80 has the folded portion P5 in which the base film 82 is folded back so that the base film 82 overlaps itself, and the folded portion P5 has uncovered surfaces of the copper foil 81, on which the cover film 83 is not formed due to the openings 83e, 83f, 83g, and 83h. That is, a folded structure and a joint structure in FIG. 6 formed of the solder S1 and S2 are employed in the present embodiment, so that the present embodiment is of practical use.

### Second Embodiment

The following will describe a second embodiment with a focus on a difference between the first embodiment and the second embodiment.

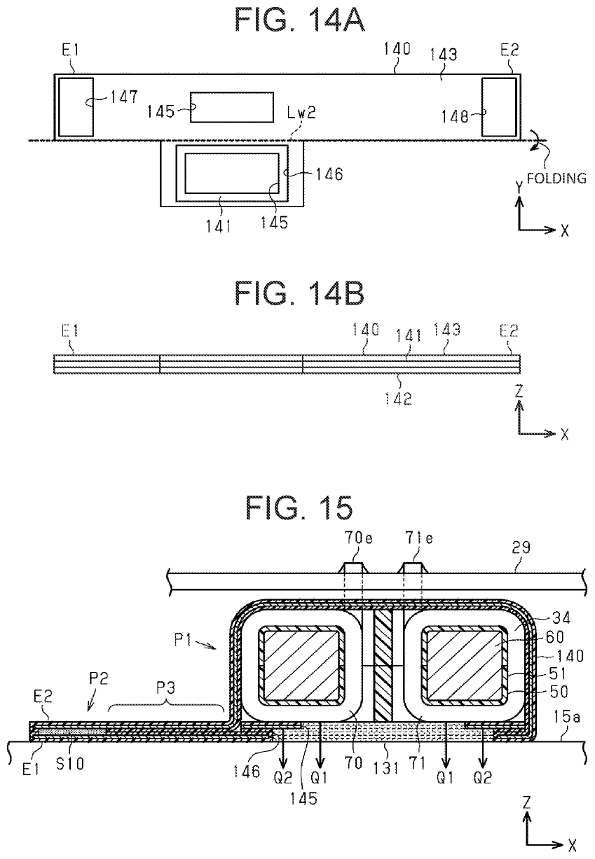

After the three-layer laminated body 80 is folded along the folding line Lw1 in FIG. 9, the three-layer laminated body 80 is joined by the solder S1 and S2, and the end portions of the three-layer laminated body 80 are joined by the solder S3 as illustrated in FIG. 6, so that the three-layer laminated body 80 is made the loop shape. On the other hand, in the second embodiment, as illustrated in FIGS. 14A and 14B, a three-layer laminated body 140 is formed by laminating a base film 142, a copper foil 141, and a cover film 143, and has a through hole 145 for heat dissipation, an opening (uncovered portion of the copper foil) 146 for heat dissipation that is larger than the through hole 145, and a pair of openings (uncovered portions of the copper foil) 147, 148 for soldering. After the three-layer laminated body 140 is folded into a mountain shape along a folding line Lw2, the copper foil 141 is made a loop shape by joining end portions of the three-layer laminated body 140 by solder S10, as illustrated in FIG. 15. The heat Q1 flowing from the winding wires 70, 71 through the through hole 145 is dissipated into the bottom wall portion 15a through a heat dissipation member 131. In addition, the heat Q2 flowing from the copper foil 141 that is uncovered by the opening 146 is dissipated into the bottom wall portion 15a through the heat dissipation member 131.

Thus, when the three-layer laminated body 80 is folded, the opposite end portions of the three-layer laminated body 80 need to be matched with each other in the first embodiment. However, this is not required in the second embodiment.

### Third Embodiment

The following will describe a third embodiment with a focus on a difference between the first embodiment and the third embodiment.

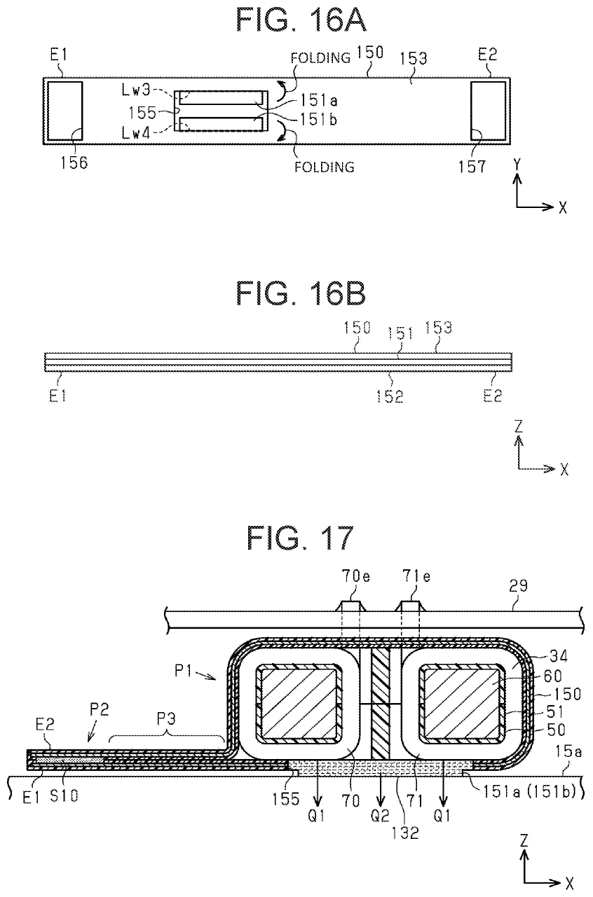

Instead of FIGS. 6 and 9, in the third embodiment, as illustrated in FIGS. 16A and 16B, a three-layer laminated body 150 is formed by laminating a base film 152, a copper foil 151, and a cover film 153 and has a through hole 155 for heat dissipation. Each of rectangular portions 151a, 151b of the copper foil 151 extends in the Y-direction inward the through hole 155 and is exposed outside. The three-layer laminated body 150 has a pair of openings (uncovered portions of the copper foil) 156, 157 for soldering. Then, after the copper foil 151 is folded along a folding line Lw3 that is located in a root portion of the rectangular portion 151a of the copper foil, and along a folding line Lw4 that is located in a root portion of the rectangular portion 151b of the copper foil, the copper foil 151 is made a loop shape by joining end portions of the three-layer laminated body 150 by solder S20, as illustrated in FIG. 17. The heat Q1 flowing from the winding wires 70, 71 through the through hole 155 is dissipated into the bottom wall portion 15a through a heat dissipation member 132. In addition, the heat Q2 flowing from the rectangular portions 151a, 151b of the copper foil is dissipated into the bottom wall portion 15a.

### Fourth Embodiment

The following will describe a fourth embodiment with a focus on a difference between the first embodiment and the fourth embodiment.

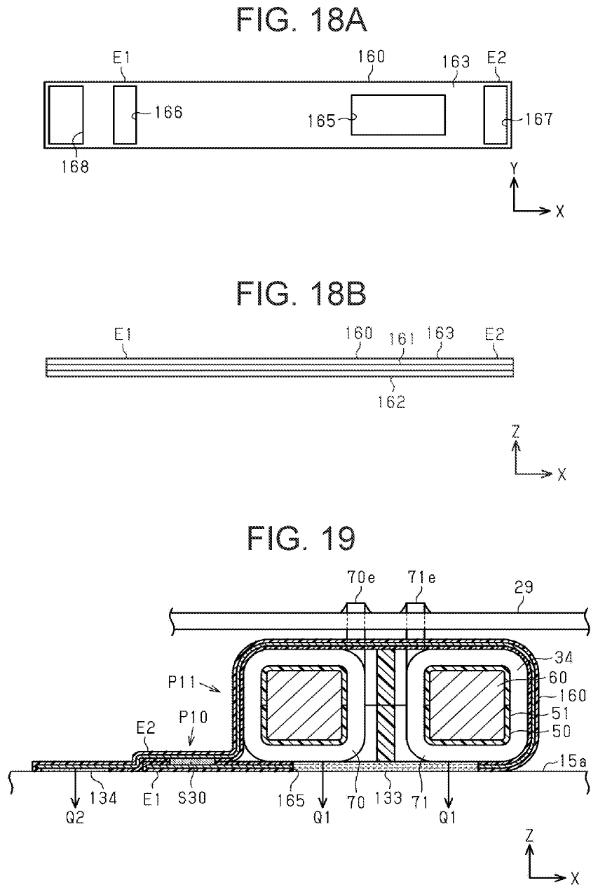

Instead of FIGS. 6 and 9, in the fourth embodiment, as illustrated in FIGS. 18A and 18B, a three-layer laminated body 160 is formed by laminating a base film 162, a copper foil 161, and a cover film 163 and has a through hole 165 for heat dissipation and a pair of openings 166, 167 for soldering. The three-layer laminated body 160 also has an opening (uncovered portion of the copper foil) 168 for heat dissipation that is located closer to an end of the three-layer laminated body 160 than the opening 166. As illustrated in FIG. 19, the copper foil 161 is made a loop shape by joining the copper foil 161 in the pair of the openings 166, 167 using solder S30. The heat Q1 flowing from the winding wires 70, 71 through the through hole 165 is dissipated into the bottom wall portion 15a through a heat dissipation member 133. In addition, the heat Q2 flowing from the copper foil 141 that is uncovered by the opening 168 is dissipated through a heat dissipation member 134.

### Fifth Embodiment

The following will describe a fifth embodiment with a focus on a difference between the fourth embodiment and the fifth embodiment.

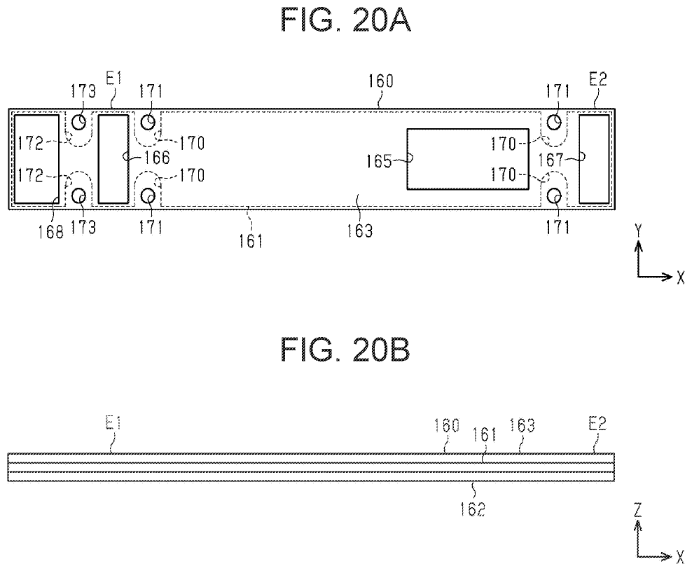

Instead of FIGS. 18A and 18B, the fifth embodiment has a configuration illustrated in FIGS. 20A and 20B.

When the three-layer laminated body 160 that is formed by laminating the base film 162, the copper foil 161, and the cover film 163 is soldered, the three-layer laminated body 160 is sandwiched between a pair of heaters and heated with opposite end portions of the three-layer laminated body 160 overlapped with each other. The copper foil 161 has a constricted portion 170 that is located between a joint portion P10 (see FIG. 19) and a loop-shaped portion P11 (see FIG. 19) that is wound around the winding wires 70, 71. The constricted portion 170 suppresses escape of heat when the copper foil 161 is joined. That is, the copper foil 161 has the constricted portion 170 that is located between the joint portion P10 and the loop-shaped portion P11 and in which a width of the copper foil 161 is reduced between the loop-shaped portion P11 and the joint portion P10. Thus, the heat when a soldering portion is heated is difficult to escape into the loop-shaped portion P11 from the soldering portion, so that reliability of the soldering is improved.

The three-layer laminated body 160 formed of the base film 162, the copper foil 161, and the cover film 163 has through holes 171 through each of which a screw is inserted for holding the loop-shaped portion P11 in the constricted portion 170 of the copper foil 161. In detail, a screw is inserted into each of the through holes 171, and screwed into the bottom wall portion 15a of the housing, by which the loop-shaped portion P11 is held. The through holes 171 may be used for the joining of the end portions of the three-layer laminated body 160 by soldering. In addition, in FIG. 20A, a constricted portion 172 and through holes 173 through each of which a screw is inserted are also formed in a position closer to the jointed end portions of the loop-shaped copper foil 161 than the joint portion P10.

It is noted that the through holes through each of which a screw is inserted may be formed irrespective of the constricted portion 170.

The present disclosure is not limited to the above-described embodiments, and may be modified as follows.

The end portion of the loop-shaped three-layer laminated body 80 formed of the base film 82, the copper foil 81, and the cover film 83 is covered by the base film 82 and the cover film 83. However, the end portion may be covered by only the base film 82 or by only the cover film 83. In short, the end portion of the three-layer laminated body 80 only needs to be covered by at least one of the base film 82 and the cover film 83.

In a configuration of the three-layer laminated body, the other material excluding the copper foil may be used as the electrical conductor. In short, the material only needs electrical conductivity and flexibility.

In a configuration of the three-layer laminated body, the first insulation layer and the second insulation layer may be made of a material excluding polyimide. In short, the material only needs insulation property and flexibility.

What is claimed is:

1. A vehicle electric compressor, comprising:
a compression part configured to compress fluid;
an electric motor configured to drive the compression part; and an inverter device configured to drive the electric motor,
the inverter device including:
an inverter circuit configured to convert DC power to AC power; and
a noise reduction unit that is connected to an input side of the inverter circuit and reduces a common mode noise and a normal mode noise in the DC power to be input to the inverter circuit,
the noise reduction unit including:
a common mode choke coil; and
a smoothing capacitor that cooperates with the common mode choke coil to form a low pass filter circuit, and
the common mode choke coil including:
a core that is formed in a ring shape;
a first winding wire that is wound around the core;
a second winding wire that is wound around the core, the second winding wire being separated from and facing the first winding wire; and
an electrical conductor that is formed in a thin film shape and has flexibility, the electrical conductor covering the core in a loop shape while the electrical conductor is looped over the first winding wire and the second winding wire, wherein
the electrical conductor has a first insulation layer attached on one surface of the electrical conductor,
the electrical conductor has a second insulation layer attached on the other surface of the electrical conductor,
the electrical conductor includes:
a first end portion on which the second insulation layer is not disposed; and
a second end portion on which the second insulation layer is not disposed and that is joined to the first end portion to form the loop shape of the electrical conductor,
the first insulation layer, the electrical conductor, and the second insulation layer form a laminated body including a loop-shaped portion that covers the core and a joint portion that protrudes outward from the loop-shaped portion and in which the first end portion and the second end portion are joined, and
the laminated body has an end portion at which the electrical conductor is covered by at least one of the first insulation layer or the second insulation layer.

2. The vehicle electric compressor according to claim 1, wherein
the laminated body has an overlap portion in which the second insulation layer overlaps itself and that is located between the loop-shaped portion and the joint portion, and extends toward the joint portion from the loop-shaped portion.

3. The vehicle electric compressor according to claim 1, wherein
the laminated body has a through hole for exposing the first winding wire and the second winding wire so as to dissipate heat.

4. The vehicle electric compressor according to claim 1, wherein
either one of the first insulation layer or the second insulation layer that is located on an outer peripheral side of the laminated body has an opening by which the electrical conductor is uncovered from the one of the first insulation layer or the second insulation layer to dissipate heat.

5. The vehicle electric compressor according to claim 1, wherein
the laminated body has a folded portion in which the first insulation layer is folded back so that the first insulation layer overlaps itself, wherein the folded portion has uncovered surfaces on which the second insulation layer is not formed.

6. The vehicle electric compressor according to claim 1, wherein
the electrical conductor has a constricted portion that is located between the joint portion and the loop-shaped portion and in which a width of the electrical conductor is reduced between the loop-shaped portion and the joint portion.

7. The vehicle electric compressor according claim 6, wherein
the laminated body has through holes through each of which a screw is inserted for holding the loop-shaped portion in the constricted portion of the electrical conductor.
